(19) United States
(12) Patent Application Publication
(10) Pub. No.: US 2013/0051220 A1
(43) Pub. Date: Feb. 28, 2013

(54) Method and Apparatus for Quick-Switch Fault Tolerant Backup Channel

(71) Applicant: Igor Ryshakov, Mountain View, CA (US)

(72) Inventor: Igor Ryshakov, Mountain View, CA (US)

(21) Appl. No.: 13/214,511

(22) Filed: Aug. 22, 2011

(51) Int. Cl. H04N 7/06; H04L 12/66; H04L 1/22; H04L 12/56

(52) U.S. Cl. 370/221; 370/401; 370/352; 725/109; 370/228

(57) ABSTRACT

In a network environment, the Quality of Service becomes an important issue particularly for applications involved with real-time multimedia streaming. Any transmission failure may cause service disruption and the failure has to be quickly recovered to minimize the impact. A unified home networking standard based on existing media in home has been developed to meet the increasing demand for bandwidth, reliability and availability. However, the fault tolerant protocol adopted by the home networking standard is based on an advanced selective ARQ (Automatic Retransmission Request) protocol which may take hundreds of millisecond to establish a backup channel. Alternatively, a hot standby backup channel has to be used to achieve quick switch without data loss at the expense of increased power consumption by the hot standby channel. The present invention discloses a quick-switch modem that can quickly switch from a primary channel to a backup channel upon detection of transmission failure. The quick-switch modem contains an additional interface between the modems for the primary channel and the secondary channel. In order to achieve quick failure detection and data re-route, the quick-switch modem relies on lower layers of the network link to facilitate failure detection and data re-route. Consequently, the switching time is substantially reduced without the need of hot standby. Alternatively, the quick-switch modem can be configured for load sharing to enhance overall available bandwidth.

### FIELD OF THE INVENTION

The present invention relates to communication systems. In particular, the present invention relates to providing fault tolerant backup channel in the MAC/PHY layer for quick switching in case of link degradation and for providing load sharing.

### BACKGROUND

In recent years, multimedia data over internet has been growing rapidly and becomes the major traffic in various networks today. Similarly, in a home environment, the in-home network traffic also grows rapidly. Unlike the older home networks, where the traffic is mostly related to file transfer, the modern home networking often involves massive multimedia traffic. The multimedia traffic may correspond to access, by a home PC or media player, of multimedia data provided by an internet multimedia data hosting site or an internet multimedia service provider. The multimedia traffic may also be associated with access of multimedia data stored on a server, another PC, or a home media gateway. While an error may be more forgiving for the file transfer application, where retransmission will take care of the problem, the transmission error will cause noticeable disturbance for multimedia streaming The multimedia data usually is stored and transmitted in a compressed form. An error in the received bit stream will often cause the error to propagate beyond the data impacted. For example, for the inter-frame coded video data such as MPEG1/2/4 and H.264, an error in the received bit stream may cause artifacts in several frames. Therefore, the network quality becomes a more concern for multimedia applications. Furthermore, the bandwidth requirement for multimedia applications is much higher than that for typical file transfer. In light of the increasing multimedia content resolution and quality, the multimedia data is taking up more sustained bandwidth than before. For example, a high-definition video may require up to 10-20 Mbps or more sustained bandwidth for good video quality.

Today several Home Networking (HN) technologies are available to the consumer. Among them, Wireless Local Area Networks (WLANs) based on the IEEE 802.11B/N/G standards, also called Wi-Fi, is the most popular in-home network technology. However, WLANs often suffer from poor Radio Frequency (RF) propagation, especially in multiple dwelling units (MDUs) with concrete walls, and from mutual interference that limits the capability to provide high-speed services with high Quality of Service (QoS) requirements for applications such as high definition video streaming. Accordingly, various wired-medium based technologies are being used for HN applications, such as power line-based, phone line-based and coaxial cable-based home networks have been standardized. Recently, a unified technology for home networking over multiple wired media is being defined by International Telecommunication Union—Telecommunication Standardization Sector (ITU-T) Recommendation G.9954, also called G.hn. The approach chosen for G.hn is a single modem optimized for multiple media.

The single unified HN technology offers various advantages such as interoperability and performance. The unified HN technology also adopts a Logical Link Control (LLC) sub-layer that ensures reliable delivery of data over home electrical wiring. The LLC employs an advanced selective ARQ (Automatic Retransmission Request) protocol that automatically re-transmits data affected by noise and provides error-free end-to-end Ethernet services to any G.hn device on the network connected to power lines, phone lines, or coaxial cables. While the ARQ scheme can improve the network reliability, the time period for detecting a transmission failure and notifying a re-route have be too long to support the time-critical multimedia transmission. Therefore, it is desired to develop a system with quick-switch fault tolerant backup channel that can quickly switch to the backup channel in case of transmission failure. Furthermore, in order to use the backup channel efficiently, it is desirable to remove the requirement of hot standby or to configure the backup channel as a secondary channel for load sharing.

### SUMMARY OF THE INVENTION

According to a first aspect of the present disclosure, there is provided a network comprising a first domain and a second domain and an inter-domain bridge connecting the first domain and the second domain.

According to another aspect, the first domain and the second domain comprise multiple nodes. The first domain is a domain master node that controls operation of the nodes. In the event the first domain fails, the domain master node functionality is passed to a second node. In another aspect, a multicarrier scheme based on OFDM to transmit and receive media and the network is a G.hn network that is connected to a second network through the bridge. The network is a G.hn network that is connected to a Global Master for coordination between domains through the bridge. In another aspect, at least three domains are associated with three different media. The three media is power line, phone line and coaxial cable video and audio.

According to another aspect of the present disclosure, there is provided a method comprising providing a first stream of data and providing a second stream of data; and video streaming using the Transmission Control Protocol (TCP) and the Internet Protocol (IP) using the first and the second stream of data. In another aspect, the method may further comprise transmitting the data packets and delivering the data packets to the G.hn compliant modems for transmission over two different media. In another aspect, the method may further comprise receiving data by respective modems over two different media and receiving data from two separate links and combined by the video stream a re-construction layer.

In yet another aspect of the present disclosure, the method may further comprise delivering data to the video element for processing and display and providing a backup channel. The method may also include providing a re-construction layer to select the best quality channel and providing two channels that operate in parallel. In another aspect, the method may include providing that a backup channel that is configured for the cold standby mode where only one data stream over the primary channel is used.

In another aspect of the present disclosure, there is provided a modem comprising: a quick-switch backup channel feature that is capable of re-routing data to secondary channel when a primary channel quality deteriorates. The modem may also include a device for transmitting and receiving data over the primary channel and the secondary channel over different media formats that are unsynchronized. The modem may also have a device that sends data using a G.hn standard coordinated by the DM and synchronized with the MAC cycle. The modem may divide the MAC cycle into time intervals associated with transmission opportunities (TXOPs) assigned by the DM for nodes in the domain. The modem may also include a device to transmit using a quick-switch fault tolerant channel that utilizes a MAC cycle synchronization technique. The modem also can include transmitting two different media in a synchronized and phase-locked manner. The modem may further include transmitters for the primary channel and the secondary channel transmitting as domain masters so that the time slots on both channels are synchronized.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 illustrates a G.hn network model having multiple domains corresponding to multiple media bridged by inter-domain bridges.

FIG. 2 illustrates an exemplary backup channel configuration according to a conventional approach, where the failure detection and data re-route occur in a high layer of the network protocol.

FIG. 3 illustrates an exemplary system embodying the quick-switch fault tolerant backup channel according to the present invention, where the failure detection and data re-route occur in a lower layer of the network protocol.

FIG. 4 illustrates a synchronized and phase-locked MAC cycle according to f the present invention.

### DETAILED DESCRIPTION OF THE INVENTION

In order to accommodate the increasing need of more bandwidth, better coverage and highly reliable communication in the home network environment, various wired-medium based technologies have been developed for Home Network (HN) applications, such as power line-based, phone line-based and coaxial cable-based HN standards. Recently, a unified technology for home networking over multiple wired media has been defined by International Telecommunication Union—Telecommunication Standardization Sector (ITU-T) Recommendation G.9954, also called G.hn. The approach chosen for G.hn is a single modem optimized for multiple media that are widely available in most existing homes.

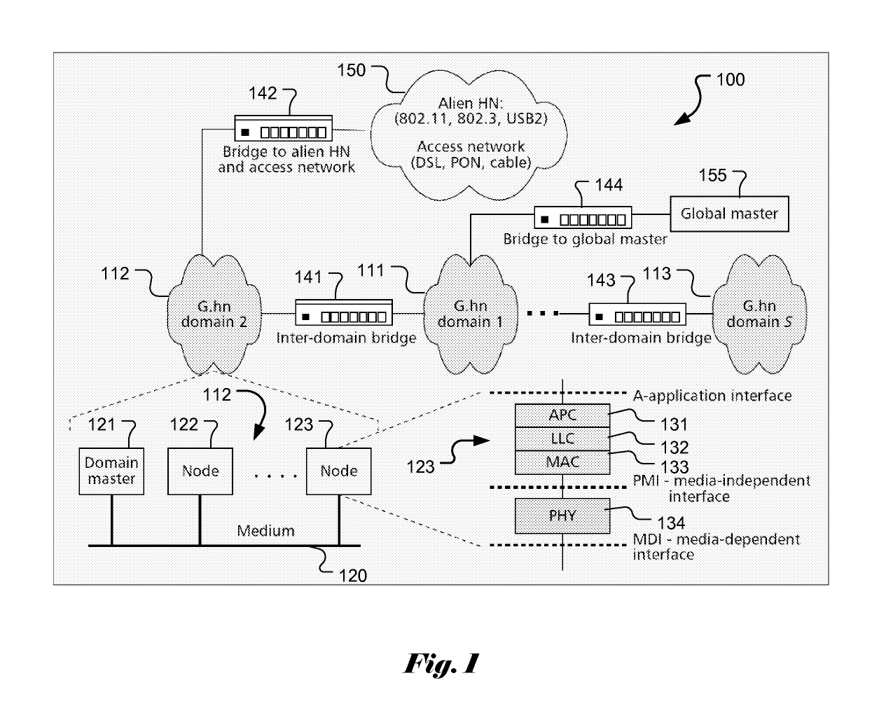

FIG. 1 shows a network having a first domain 111 connected to a second domain 112 and a third domain 113. The first domain 111 is connected to the second domain 112 by a first inter-domain bridge 141. The first domain 111 is connected to the third domain 113 by a bridge 143. The second domain 112 is connected to a domain master 121 and a first and second node 122 and 123. The second domain 112 is connected to a domain 150 by a bridge 142. First domain is connected to a global master 155 by a bridge 144. A node 123 is shown that includes an APC, LLC, MAC and a media independent interface. Ghn is the common name for a home network technology standard developed under the International Telecommunication Union (ITU-T) and promoted by the Home Grid Forum. Ghn supports networking over power lines, phone lines and coaxial cables with data rates up to 1 Gbit/s.

G.hn specifies a single Physical Layer based on fast Fourier transform (FFT) orthogonal frequency-division multiplexing (OFDM) modulation and low-density parity-check code (LDPC) forward error correction (FEC) code. G.hn includes the capability to notch specific frequency bands to avoid interference with amateur radio bands and other licensed radio services. G.hn includes mechanisms to avoid interference with legacy home networking technologies and also with other wire line systems such as VDSL2 or other types of DSL used to access the home. OFDM systems split the transmitted signal into multiple orthogonal sub-carriers. In G.hn each one of the sub-carriers is modulated using QAM. The maximum QAM constellation supported by G.hn is 4096-QAM (12-bit QAM) The G.hn Media Access Control is based on a time division multiple access (TDMA) architecture, in which a “domain master” schedules Transmission Opportunities (TXOPs) that can be used by one or more devices in the “domain”. There are two types of TXOPs: Contention-Free Transmission Opportunities (CFTXOP), which has a fixed duration and are allocated to a specific pair of transmitter and receiver. CFTXOP are used for implementing TDMA Channel Access for specific applications that require quality of service (QoS). Shared Transmission Opportunities (STXOP), which are shared among multiple devices in the network. STXOP are divided into Time Slots (TS).

FIG. 1 illustrates a G.hn network model 100 having multiple domains 111-113 corresponding to multiple media bridged by inter-domain bridges 141-144. Each domain comprises multiple nodes. For example, the domain 112 comprises nodes 121-123, where each node is coupled to the medium 120. One of the nodes is designated as Domain Master (DM) (in this example, node 121) that controls operation of all nodes in the domain, including admission to the domain, bandwidth reservation, resignation, and other management operations. In case a DM fails, the DM function is passed to another node in the domain. In order to use the same design for various media, the G.hn modems are parameterized so that relevant parameters can be set depending on the wiring type. For example, a basic multicarrier scheme based on windowed OFDM has been chosen for all media, but some OFDM parameters, such as number of subcarriers and subcarrier spacing, are media-dependent. Similarly, the same Forward Error Correction (FEC) is used for all media. However, a particular set of coding rates and block sizes are defined for each type of media. A parameterized approach also allows to some extent optimization on a per media basis to address the different channel characteristics of in-home wires without sacrificing modularity, flexibility, and cost. The G.hn network may be connected to an access network or an alien network 150 through a bridge 142. The G.hn network is also connected to a Global Master 155 for coordination between domains through a bridge 144 as shown in FIG. 1. Three domains are illustrated in FIG. 1, where the three domains may be associated with three different media—power line, phone line and coaxial cable.

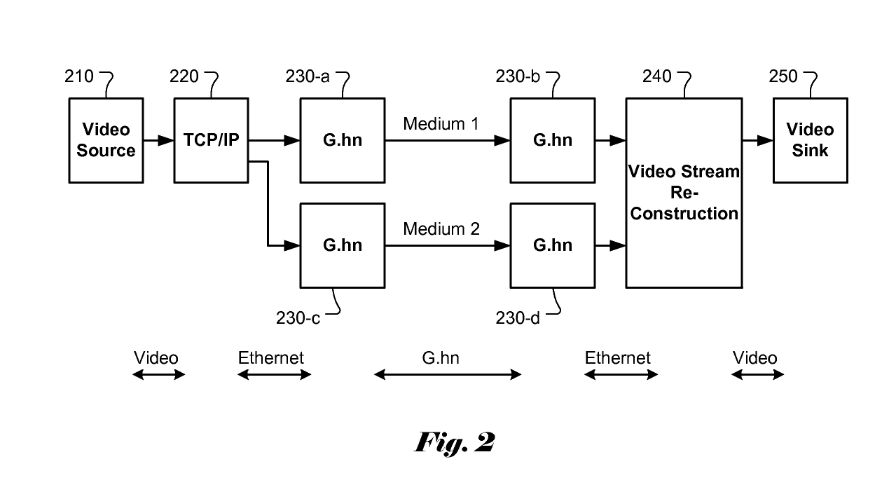

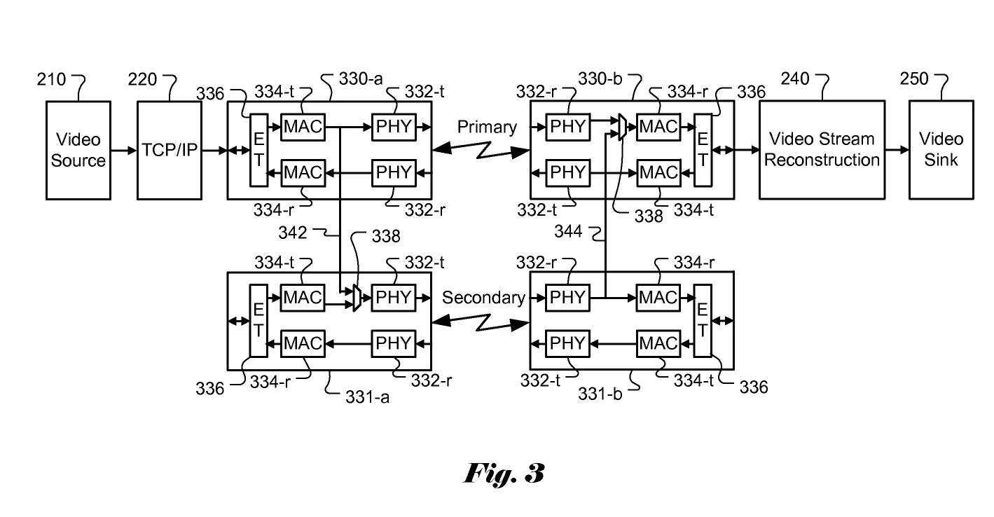

FIG. 2 illustrates a number of components in a high-level block diagram. FIG. 2 shows a video source 210 being connected to a TCP-IP element 220 and which is connected to the networks via at least two medium. The networks are connected as shown by a video stream reconstruction element 240 and a video sink element 250. FIG. 3 show a detailed network diagram that includes an MAC element 334 and a PHY element 332.

In a network, channel redundancy may have to be provided in order to cope with link failure. FIG. 2 illustrates a redundant channel arrangement for the G.hn technology according to a conventional solution. The scenario illustrated in FIG. 2 corresponds to video streaming from a video source 210 to a video sink 250. The video source 210 may be on a server, another Personal Computer (PC) or a media gateway and the video sink 250 may a PC, a Portable Media Player (PMP), or a networked television. The video source 210 and video sink 250 may be coupled to nodes on different media. In the field of network protocol, the system interconnection model is often viewed as layered structure with physical (PHY) layer as the lowest layer, which defines the electrical and physical specifications for devices. In particular, it defines the relationship between a device and a transmission medium. The Data Link Layer (DLL) provides the functional and procedural means to transfer data between network entities and to detect and possibly correct errors that may occur in the physical layer. The data link layer specifies network and protocol characteristics, including physical addressing, network topology, error notification, sequencing of frames, and flow control. The data link layer may comprise a logical link control (LLC) sub-layer and a Media Access Control (MAC) sub-layer. While the MAC layer is widely adopted in most protocols, the LLC layer is not used for most protocols on the Ethernet. However, LLC is adopted in the G.hn standard to provide the ARQ protocol. In addition, the G.hn standard uses a third sub-layer—Application Protocol Convergence (APC) layer in the data link layer, which accepts frames (usually in Ethernet format) from the upper layer (Application Entity) and encapsulates them into G.hn MAC Service Data Units (APDUs). The data link layer and the physical layer are closely related to the characteristics of the underlying medium and these two layers are considered as part of the media layer while some upper layers are considered as host layers. The PHY 134, MAC 133, LLC 132 and APC 131 layers used in the G.hn standard are shown in FIG. 1. The scope of the G.hn standard deals with the specifications for the data link layer and the physical layer.

FIG. 2 illustrates an example of video streaming using the Transmission Control Protocol (TCP) and the Internet Protocol (IP) 220. The data packets are delivered to the G.hn compliant modems 230-a and 230-c for transmission over two different media: Medium 1 and Medium 2. The data will be received by respective G.hn modems 230-b and 230-d over two different media: Medium 1 and Medium 2. The video data received from two separate links are combined by the video stream re-construction layer 240 and delivered to the video sink 250 for processing and/or display. The backup channel shown in FIG. 2 can be configured as a hot standby mode or a cold standby mode. In the hot standby mode, the two data streams are always fed to the two G.hn modems 230-a and 230-c simultaneously, and received by the two G.hn modems 230-b and 230-d. The video stream re-construction layer 240 will select the best quality channel and use the data from the best channel. In case that the channel quality corresponding to the primary medium deteriorates, the backup channel corresponding to the secondary medium will be used to provide data to the video stream re-construction layer 240. In this case, the switching can be very fast and seamless, and the system will be free from any data loss. Since both channels are fully operational parallelly, the power consumed by the links will be twice as much compared with a system without the backup channel. Alternatively, the backup channel may also be configured for the cold standby mode where only one data stream over the primary channel is used in a normal condition. When the channel quality corresponding to the primary medium deteriorates, the backup channel corresponding to the secondary medium will be used to deliver data. The video stream re-construction layer 240 picks up the stream upon failure detection and notification of re-route. However, the failure detection and notification of re-route can take hundreds of millisecond (msec). Data loss during the period may be substantial and causes severe quality degradation.

As described above, the hot standby mode can quickly react to channel deterioration without data loss. However, this configuration will cause the modems to consume twice as much power as a system without backup channel. On the other hand, the cold standby mode only uses one pair of modems at a time so that the modems consume the same amount of power as the system without a backup channel. However, the cold standby system may cause severe data loss during channel switching. A system embodying the quick-switch fault tolerant backup channel according to the current invention is illustrated in FIG. 3. The system comprises a pair of modems 330-a and 330-b to provide the primary channel and another pair of modems 330-c and 330-d to provide the backup channel. The primary and backup modems on each side include a quick-switch interface between the two modems for re-routing data. For example, the transmit side modems 330-a and 331-a include an interface 342 to re-route data from the MAC 334-t of the primary modem 330-a to the PHY 332-t of the backup modem 331-a. On the receive side, the modem 330-b and the modem 331-b include an interface 344 to re-route data received by the PHY 332-r of the backup modem 331-b to the MAC 334-r of the primary modem 330-b. Since the drawing in FIG. 3 only illustrates components involved in video data stream from the video source 210 to the video sink, some parts are not shown in the figure. It is understood that some components/interfaces are included in the modems 330-a and 331-a to provide the interface 344 similar to the modems 330-b and 331-b. Furthermore, some components/interfaces are included in the modems 330-b and 331-b to provide the interface 342 similar to the modems 330-a and 331-a.

In the system shown in FIG. 3, the video traffic flows from the video source 210 to the video sink 250. For the primary channel, the MAC 334-t in the modem 330-a, is capable of re-routing data to the modem 331-a of the backup channel through the path 342. On the receiving end, the re-routed data will be received by the modem 331-b through the backup channel and be provided to the MAC 334-r of the primary modem 330-b. The MAC 334 in modem 330-b can select the re-routed data transmitted through backup channel using multiplexer 338. An element 336 is used as an interface with the upper layer

As shown in FIG. 3, the quick-switch fault tolerant backup channel is provided by re-routing data at the output of transmit MAC 334-t of modem 330-a to the backup modem 331-a. Channel deterioration at the receiver side is detected by the PHY 332-r at the primary modem 330-b. Upon the detection of channel deterioration, the modem 330-b may provide a signal to primary modem 330-a to notify the occurrence of channel deterioration. The path of failure detection involves is from the output of the MAC 334-t to the PHY 332-t of modem 330-a and to the PHY 332-r and the MAC 334-r of the modem 330-b. Upon the failure detected, a message may be provided from MAC 334-t to the PHY 332-t of the modem 330-b and to the PHY 332-r and the MAC 334-r at the modem 330-a. Accordingly, the MAC 334-t will re-route the traffic through the quick-switch fault tolerant backup channel. Compared with the fault tolerant system of FIG. 2, the failure detection path and traffic re-route path of FIG. 3 are much shorter. Consequently, the modems incorporating the quick-switch fault tolerant backup channel can substantially shorten the switching time from hundreds of msec to about 40 msec.

FIG. 3 illustrates the scenario of video streaming from the video source 210 to the video sink 250. The MAC 334-t in the modem 330-a is shown to be able to re-route data to the backup channel. Nevertheless, the modem is bi-directional and the MAC 334-t in the modem 330-b also has the capability of re-routing data to the backup channel, where the path of re-routing is not shown in FIG. 3. Similarly, a multiplexer 338 is also incorporated, but not shown in FIG. 3, at the input of the PHY 332-t to select data from the MAC 334-t in the modem 330b or the MAC 334-t in the modem 331b. Furthermore, the data received by the PHY 332-r in the modem 331-a can be re-routed to the MAC 34-r in the modem 330-a, and a multiplexer 338 is incorporated at the input of the MAC 334-r of the modem 330-a to select data from the primary channel or the backup channel. The re-route path from the PHY 332-r in the modem 31-a and the multiplexer 338 at the input of the MAC 334-r of the modem 330-a are not shown in FIG. 3. It is understood that these components were not shown in FIG. 3 for simplicity since FIG. 3 is mainly intended to describe a scenario of data flow from the video source 210 to the video sink 250.

The exemplary system with the quick-switch fault tolerant backup channel shown in FIG. 3 provides a quick-switch channel by re-routing data from a location between the MAC and the PHY. The quick-switch channel may also be provided by re-routing data from other locations such as within the PHY or within the MAC where failure detection and re-route decision can be made in a lower layer.

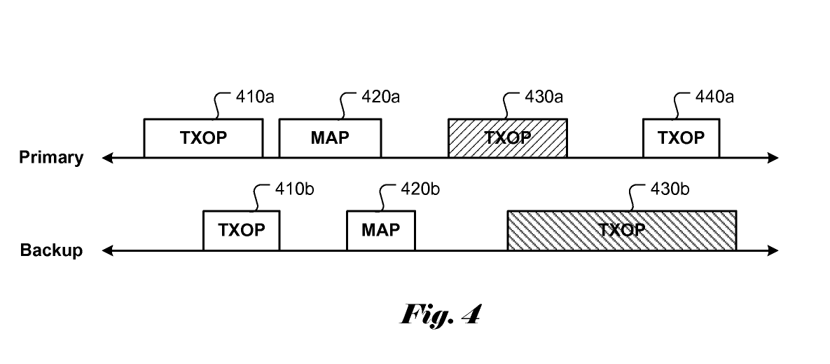

The modem incorporating the quick-switch backup channel feature is capable of quickly re-route data to secondary channel when the primary channel quality deteriorates. Since the primary channel and the secondary channel may be over different media, the data on the two different media may not be synchronized. Therefore, the re-routed data may not be properly handled in the secondary channel. The G.hn standard defines synchronized media access coordinated by the DM and synchronized with the MAC cycle. The MAC cycle is divided into time intervals associated with transmission opportunities (TXOPs) assigned by the DM for nodes in the domain. The DM assigns at least one TXOP to transmit the media access plan (MAP) frame, which describes the boundaries of the TXOPs assigned for one or several following MAC cycles. In order to allow channel switching smoothly across two different media, the system incorporating quick-switch fault tolerant channel utilizes a MAC cycle synchronization technique. The MAC cycles of two channels over two different media are synchronized and phase-locked, as shown in FIG. 4. Since the G.hn is based on a time division protocol for multiple nodes on the channel to share bandwidth, the domain master for each respective medium is responsible for time slot assignment. In order to be able to synchronize the MAC cycle, the transmitters for the primary channel and the secondary channel have to be domain masters so that the time slots on both channels are synchronized. For example, each time slot, regardless TXOP or MAP on the primary channel (410a, 420a, and 430a), there is always a respective time slot on the secondary channel (410b, 420b, and 430b). A first and a second TXQP block 430a and 430b is shown and that is located on the primary and backup location.

When data transmitted in one time slot is deteriorated, the receiving end will detect the failure during the time slot or shortly after. Upon the detection of a failure, the receiving end may notify the transmitting end according to a pre-defined protocol. This action will be taken up by the receiving side modem incorporating the quick-switch fault tolerant channel feature during the next available time slot I the reverse channel. Accordingly the transmit side modem can re-route the data in the next time slot. According to a first aspect, the method may switch data based on limited information. For example, a code may be embedded into the data and the code may provide data to provide the channel switching.

It will therefore be readily understood by those persons skilled in the art that the present invention is susceptible of broad utility and application. Many embodiments and adaptations of the present invention other than those described, as well as many variations, modifications and equivalent arrangements will be apparent from or reasonably suggested by the present invention and the foregoing description, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements, the present invention being limited only by the claims appended hereto and the equivalents thereof

The invention may be embodied in other specific forms without departing from its spirit or essential characteristics. The described examples are to be considered in all respects only as illustrative and not restrictive. The scope of the invention is, therefore, indicated by the appended claims rather than by the foregoing description. All changes, which come within the meaning and range of equivalency of the claims, are to be embraced within their scope.

What is claimed is:

1: A network comprising:
a first domain;
a second domain;
an inter-domain bridge connecting the first domain and the second domain.

2: The network of claim 1, wherein the first domain and the second domain comprise multiple nodes.

3: The network of claim 2, wherein the first domain is a domain master node that controls operation of the nodes.

4: The network of claim 3, wherein in the event the first domain fails, wherein the domain master node functionality is passed to a second node.

5: The network of claim 4, further comprising a multicarrier scheme circuit based on OFDM to transmit and receive media.

6: The network of claim 1, wherein the domain is associated with a network is a G.hn network that is connected to a second network through the bridge.

7: The network of claim 1, wherein the second domain is associated with a second network is a G.hn network that is connected to a Global Master for coordination between domains through the bridge.

8: The network of claim 1, wherein at least three domains are associated with three different media.

9: The network of claim 8, wherein the three media is power line, phone line and coaxial cable video and audio.

10: A method comprising:
providing a first stream of data;
providing a second stream of data; and
video streaming using the Transmission Control Protocol (TCP) and the Internet Protocol (IP) using the first and the second stream of data.

11: The method of claim 10, further comprising transmitting the data packets so the packets are delivered to a G.hn compliant modems for transmission over two different media.

12: The method of claim 11, further comprising receiving data by the Ghn complaint modems and further comprising transmitting two different media.

13: The method of claim 12, further comprising: receiving data from two separate links and combined by a video stream reconstruction layer.

14: The method of claim 13, further comprising delivering data to a video element for processing and display.

15: The method of claim 11, further comprising: providing a backup channel.

16: The method of claim 15, further comprising: providing a reconstruction layer to select a first quality channel.

17: The method of claim 16, further comprising providing two channels that operates in parallel.

18: The method of claim 16, further comprising providing that a backup channel may also be configured for the cold standby mode where only one data stream over the primary channel is used.

19: A modem comprising:
a quick-switch backup channel feature that is capable of re-routing data to secondary channel when a primary channel quality deteriorates.

20: The modem of claim 19, further comprising: a device for transmitting and receiving data over the primary channel and the secondary channel over different media formats that are unsynchronized.

21: The modem of claim 20, further comprising: a device that sends data using a G.hn standard coordinated by a DM and synchronized with a MAC cycle.

22: The modem of claim 21, further comprising dividing the MAC cycle into time intervals associated with transmission opportunities (TXOPs) assigned by the DM for nodes in the domain.

23: The modem of claim 22, further comprising a device to transmit using a quick-switch fault tolerant channel that utilizes the MAC cycle synchronization technique.

24: The modem of claim 23, further comprising: transmitting two different media in a synchronized and phase-locked manner.

25: The modem of claim 24, further comprising: transmitters for the primary channel and the secondary channel transmitting as domain masters so that the time slots on the primary and the secondary channels are synchronized.

26: A quick-switch modem comprising:
a device having a switch that switches from a primary channel to a backup channel upon detection of transmission failure.

27: The modem of claim 26, wherein the quick-switch modem comprises an additional interface between the modems for the primary channel and the secondary channel.

28: The modem of claim 27, further comprising a detector to sample a layer to facilitate failure detection and data rerouting.

29: The modem of claim 27, further comprising: an output for switching to a mode for load sharing to enhance overall available bandwidth.

30: A processor comprising:
an input;
an output; and
a circuit operable with a ghn network having a switch that switches from a primary channel to a backup channel upon detection of transmission failure.
